(19) United States
(12) Patent Application Publication
(10) Pub. No.: US 2007/0233848 A1
(43) Pub. Date: Oct. 4, 2007

(54) Monitor management that enables enhanced data collection

(75) Inventor: Denilson Nastacio, Apex, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/391,653

(22) Filed: Mar. 28, 2006

(51) Int. Cl. G06F 15/173

(52) U.S. Cl. 709/224

(57) ABSTRACT

A solution for managing a monitor that includes enhanced data collection capabilities is provided. A set of triggers, each of which is capable of monitoring a computing environment for a condition, and a set of collectors each of which is capable of collecting environment information for the computing environment are obtained. A set of links that define a relationship between a trigger and a collector can be defined by a user and used to generate the monitor. In this manner, the monitor is configurable to collect any combination of data about the computing environment in response to the presence/occurrence of the condition. The collected data can then be used to provide an improved analysis of environment data to identify any unknown existing relationships, root causes of problems, and/or the like.

### FIELD OF THE INVENTION

The invention relates generally to managing monitors, and more particularly, to a solution for generating a monitor having enhanced data collection capabilities.

### BACKGROUND OF THE INVENTION

An event correlation engine processes events originated from one or more sources in a network to establish relationships across the events, and possibly point to a root cause of an event that a system administrator otherwise may not notice. The success of the event correlation engine is largely dictated by an availability of sufficient data to arrive at an accurate conclusion. To date, the event correlation engine receives event data from various sensors located at various computing systems (e.g., computing devices, routers, etc.) in the network. Each sensor detects a particular type of event, and collects and forwards a certain type of data on the event to the event correlation engine. The event correlation engine then processes the event data using a set of correlation rules. This arrangement is targeted at automating the resolution of known problems, but is limited in its ability to explore unknown existing relationships.

In view of the foregoing, a need exists to overcome one or more of the deficiencies in the related art.

### BRIEF SUMMARY OF THE INVENTION

The invention provides a solution for managing a monitor that includes enhanced data collection capabilities. A set of triggers, each of which is capable of monitoring a computing environment for a condition, and a set of collectors each of which is capable of collecting environment information for the computing environment are obtained. A set of links that define a relationship between a trigger and a collector can be defined by a user and used to generate the monitor. In this manner, the monitor is configurable to collect any combination of data about the computing environment in response to the presence/occurrence of the condition. The collected data can then be used to provide an improved analysis of environment data to identify any unknown existing relationships, root causes of problems, and/or the like.

A first aspect of the invention provides a method of managing a monitor, the method comprising: obtaining a set of triggers, each trigger being capable of monitoring a computing environment for a condition; obtaining a set of collectors, each collector being capable of collecting environment information for the computing environment; obtaining a set of links, each link defining a relationship between a trigger in the set of triggers and a collector in the set of collectors; and generating a monitor based on the set of links.

A second aspect of the invention provides a system for managing a monitor, the system comprising: a system for obtaining a set of triggers, each trigger being capable of monitoring a computing environment for a condition; a system for obtaining a set of collectors, each collector being capable of collecting environment information for the computing environment; a system for obtaining a set of links, each link defining a relationship between a trigger in the set of triggers and a collector in the set of collectors; and a system for generating a monitor based on the set of links.

A third aspect of the invention provides a program product stored on a computer-readable medium, which when executed, enables a computer infrastructure to manage a monitor, the program product comprising computer program code for enabling the computer infrastructure to: obtain a set of triggers, each trigger being capable of monitoring a computing environment for a condition; obtain a set of collectors, each collector being capable of collecting environment information for the computing environment; obtain a set of links, each link defining a relationship between a trigger in the set of triggers and a collector in the set of collectors; and generate a monitor based on the set of links.

A fourth aspect of the invention provides a method of generating a system for managing a monitor, the method comprising: providing a computer infrastructure operable to: obtain a set of triggers, each trigger being capable of monitoring a computing environment for a condition; obtain a set of collectors, each collector being capable of collecting environment information for the computing environment; obtain a set of links, each link defining a relationship between a trigger in the set of triggers and a collector in the set of collectors; and generate a monitor based on the set of links.

A fifth aspect of the invention provides a business method for managing a set of monitors, the business method comprising managing a computer infrastructure that performs the process described herein; and receiving payment based on the managing.

The illustrative aspects of the present invention are designed to solve one or more of the problems herein described and/or one or more other problems not discussed.

### BRIEF DESCRIPTION OF THE DRAWINGS

These and other features of the invention will be more readily understood from the following detailed description of the various aspects of the invention taken in conjunction with the accompanying drawings that depict various embodiments of the invention.

FIG. 1 shows an illustrative environment for managing a set of monitors according to an embodiment of the invention.

FIG. 2 shows an illustrative data flow diagram for the environment of FIG. 1 according to an embodiment of the invention.

FIG. 3 shows an illustrative monitor definition interface according to an embodiment of the invention.

FIG. 4 shows a data flow diagram for an illustrative monitor after implementation on a computing environment according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing a monitor that includes enhanced data collection capabilities. A set of triggers, each of which is capable of monitoring a computing environment for a condition, and a set of collectors each of which is capable of collecting environment information for the computing environment are obtained. A set of links that define a relationship between a trigger and a collector can be defined by a user and used to generate the monitor. In this manner, the monitor is configurable to collect any combination of data about the computing environment in response to the presence/occurrence of the condition. The collected data can then be used to provide an improved analysis of environment data to identify any unknown existing relationships, root causes of problems, and/or the like. As used herein, unless otherwise noted, the term “set” means one or more (i.e., at least one) and the phrase “any solution” means any now known or later developed solution.

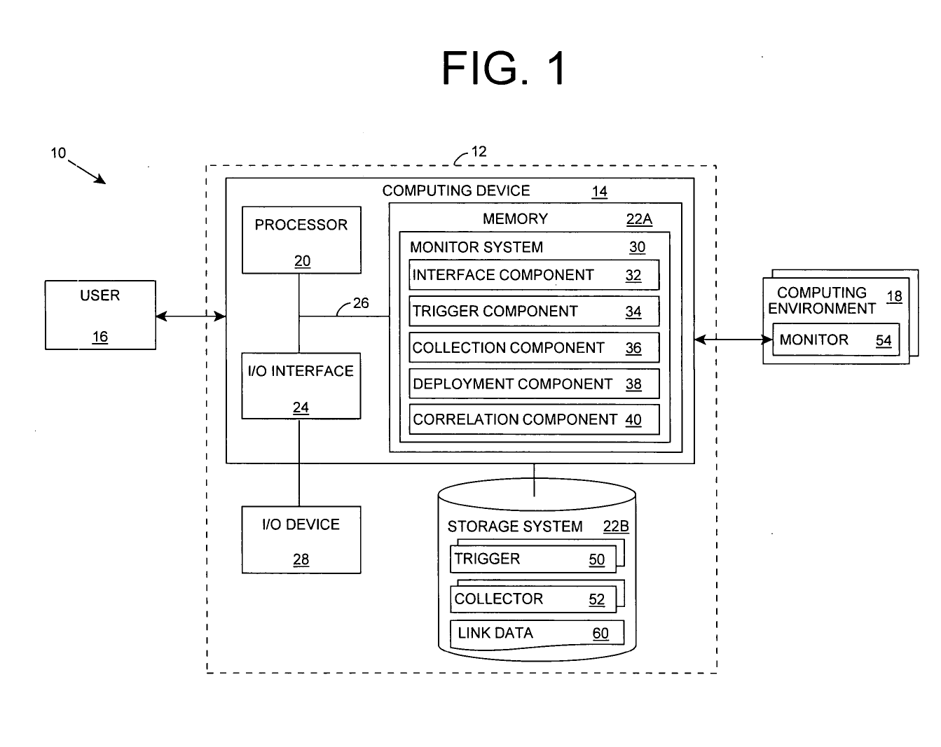

Turning to the drawings, FIG. 1 shows an illustrative environment 10 for managing a set of monitors 54 according to an embodiment of the invention. To this extent, environment 10 includes a computer infrastructure 12 that can perform the process described herein in order to manage the set of monitors 54. In particular, computer infrastructure 12 is shown including a computing device 14 that comprises a monitor system 30, which makes computing device 14 operable to manage monitor(s) 54 by performing the process described herein. To this extent, monitor system 30 enables computing device 14 to generate monitor 54 based on link data 60 that defines a set of links between a set of triggers 50 and a set of collectors 52.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as monitor system 30, which is stored in memory 22A and/or storage system 22B. While executing computer program code, processor 20 can read and/or write data, such as link data 60, to/from memory 22A, storage system 22B, and/or I/O interface 24. Bus 26 provides a communications link between each of the components in computing device 14. I/O device 28 can comprise any device that transfers information between a user 16 and computing device 14. To this extent, I/O device 28 can comprise a user I/O device to enable an individual user 16 to interact with computing device 14 and/or a communications device to enable a system user 16 to communicate with computing device 14 using any type of communications link.

In any event, computing device 14 can comprise any general purpose computing article of manufacture capable of executing computer program code installed thereon (e.g., a personal computer, server, handheld device, etc.). However, it is understood that computing device 14 and monitor system 30 are only representative of various possible equivalent computing devices that may perform the process described herein. To this extent, in other embodiments, the functionality provided by computing device 14 and monitor system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed herein, monitor system 30 enables computer infrastructure 12 to manage a set of monitors 54. To this extent, monitor system 30 is shown including an interface component 32, a trigger component 34, a collection component 36, a deployment component 38, and a correlation component 40. Operation of each of these components is discussed further herein. However, it is understood that some of the various systems/components shown in FIG. 1 can be implemented independently, combined, and/or stored in memory for one or more separate computing devices that are included in computer infrastructure 12. Further, it is understood that some of the systems/components and/or functionality discussed herein may not be implemented, or additional systems/components and/or functionality may be included as part of computer infrastructure 12.

Regardless, the invention provides a solution for managing monitor(s) 54. In general, monitor system 30 can generate monitor(s) 54 using trigger(s) 50 and collector(s) 52. To this extent, monitor system 30 enables user 16 to link/associate a trigger 50 with one or more collectors 52. Each trigger 50 can comprise a program object or the like that is capable of monitoring a computing environment 18 for the presence/occurrence of a condition. The condition can comprise any type of situation on computing environment 18. For example, the condition can comprise an availability/usage of a particular resource (e.g., processing memory, and/or the like) of computing environment 18 going below/above a predefined range/threshold, an occurrence of a particular type of interrupt, a status/transition of a process/application, and/or the like.

Likewise, each collector 52 can comprise a program object or the like that is capable of collecting a particular type of environment information for computing environment 18. The environment information can comprise any type of information on one or more resources of computing environment 18. For example, the environment information can comprise a list of applications/processes executing in computing environment 18, amount(s) of resource(s) being used, a current status of a process/application, and/or the like. Regardless, each trigger 50 and collector 52 can comprise any type of compiled, interpreted, and/or comparable type of program object. For example, the program object can comprise an executable program, an object file, source code for generating a compiled program object, an interpreted program, and/or the like.

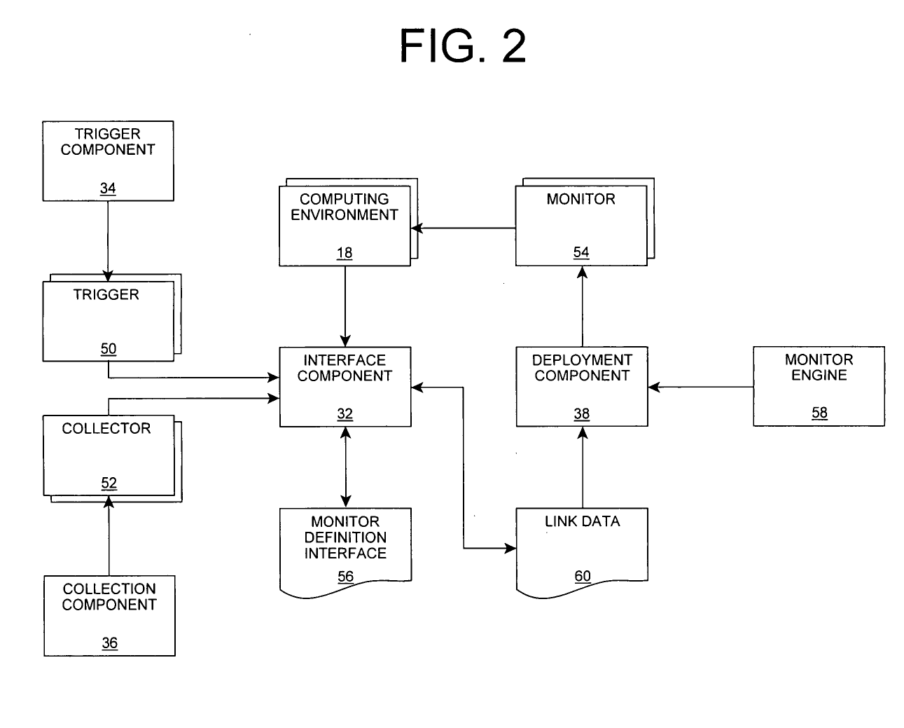

In any event, FIG. 2 shows an illustrative data flow diagram for environment 10 (FIG. 1) according to an embodiment of the invention. Trigger component 34 manages a set of triggers 50, while collection component 36 manages a set of collectors 52. In general, each component 34, 36 can enable a user 16 (FIG. 1) to request various operations (e.g., read, write, modify, delete, etc.) on the corresponding program object(s) 50, 52 and perform the requested operations. User 16 can request an operation using any solution. For example, components 34, 36 can generate a user interface for display to user 16, which renders some or all of the data for a program object 50, 52, and enables user 16 to request one or more actions. Further, components 34, 36 can define an application program interface (API) or the like that enables user 16, another system in this case, to request one or more actions and receive data on program object(s) 50, 52.

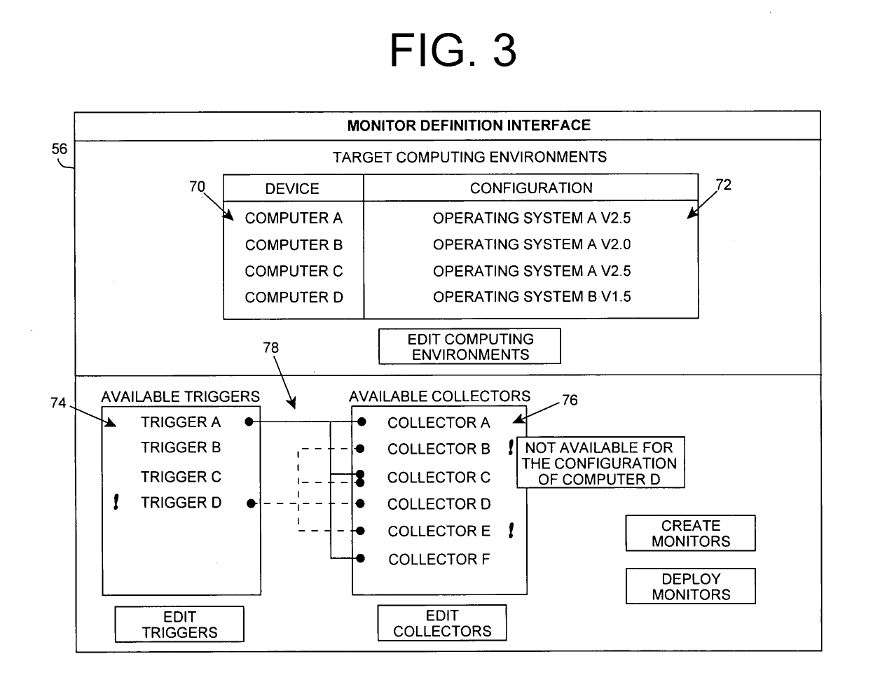

Interface component 32 can enable user 16 (FIG. 1) to define a set of links (stored as link data 60) between trigger(s) 50 and collector(s) 52. To this extent, interface component 32 can generate a monitor definition interface 56 for display to user 16. FIG. 3 shows an illustrative monitor definition interface 56 according to an embodiment of the invention. Interface 56 is shown displaying a set of target computing environments (devices) 70 along with configuration information 72 for each target computing environment 70. In general, configuration information 72 can comprise any type of configuration information 72, e.g., operating system type/version (as shown), hardware configuration, basic input output system (BIOS) type/version, and/or the like, for the corresponding target computing environment 70.

Referring to FIGS. 2 and 3, interface component 32 can obtain target computing environment(s) 70 using any solution. For example, interface component 32 can generate a user interface that lists all computing environments 18 available on a network and enables user 16 to select one or more computing environments 18 for inclusion in the set of target computing environments 70. Further, interface component 32 can obtain the available computing environments 18 and/or configuration information 72 for each target computing environment 70 using any solution. For example, interface component 32 can query each computing environment 18, query a data store of data on computing environments 18, and/or query another system that can obtain and provide available computing environments 18 and/or configuration information 72.

In any event, interface 56 further includes a set of available triggers 74 and a set of available collectors 76. Interface component 32 can obtain the set of available triggers 74 from trigger component 34 using any solution. For example, the set of available triggers 74 can comprise all triggers 50 managed by trigger component 34. Alternatively, the set of available triggers 74 can be selected from all triggers 50 based on the set of target computing environments 70. To this extent, interface component 32 can provide the set of target computing environments 70 and/or the corresponding configuration information 72 to trigger component 34, which can provide interface component 32 with each trigger 50 that is compatible with at least one of the target computing environments 18 and/or configuration information 72. For example, a trigger 50 may require a particular type/version of operating system on computing environment 18. Likewise, interface component 32 can obtain the set of available collectors 76 from collector component 36 using any solution, such as one similar to those described with respect to the set of

When the set of target computing environments 70 includes multiple computing environments 18, one or more of the set of available triggers 74 and/or set of available collectors 76 may not be compatible with each target computing environment 18. In this case, interface component 32 can provide an indication to user 16 (FIG. 1). For example, interface 56 is shown displaying a warning indicator (e.g., an exclamation point) for “TRIGGER D”. Further, user 16 can select the warning indicator (e.g., by hovering a mouse over it, right/left clicking on the indicator, etc.), and interface component 32 can provide further details regarding the indication (e.g., displayed in a popup window as shown for the warning indicator for “COLLECTOR B”). It is understood that this is only an illustrative solution, and interface component 32 can implement any solution.

Regardless, interface 56 enables user 16 (FIG. 1) to manage a set of links 78 between the set of available triggers 74 and the set of available collectors 76. Each link defines a relationship between a trigger 50 and a collector 52. In particular, each link indicates that when trigger 50 detects the corresponding monitored condition, each related collector 52 should collect the corresponding environment information. In one embodiment, interface component 32 can obtain a set of default links from link data 60. The set of default links can define, for a trigger 50, one or more collectors 52 that can collect the corresponding environment information. For example, “TRIGGER A” could have a default link with “COLLECTOR A”, and as a result, the set of links 78 could include a link between “TRIGGER A” and “COLLECTOR A”. In this manner, user 16 is not required to define commonly used links in the set of links 78. However, it is understood that user 16 could choose to remove one or more of the default links from the set of links 78.

User 16 (FIG. 1) can use interface 56 to define, modify, delete, and/or the like, links in the set of links 78 using any solution. For example, user 16 can use a mouse or the like to drag a connection from a trigger 50 in the set of available triggers 74 to a collector 52 in the set of available collectors 76. Interface 56 can display each link in the set of links 78 using any solution. To this extent, the link(s) for each trigger 50 can be displayed using a unique color, style, and/or the like.

In any event, once user 16 (FIG. 1) has defined a desired set of links 78, user 16 can select to generate one or more monitors 54 (e.g., by selecting a “CREATE MONITORS” button in interface 56). In this case, deployment component 38 can obtain link data 60 (e.g., which comprises the set of links 78) and generate one or more monitors 54 based on link data 60. In one embodiment, deployment component 38 obtains a monitor engine 58, which can implement the various links defined by link data 60 between trigger(s) 50 and collector(s) 52. In particular, deployment component 38 can provide monitor engine 58 with a reference to a trigger 50 and its corresponding collector(s) 52. Monitor engine 58 can include functionality that is able to initiate trigger 50, receive a notification of a situation from trigger 50, invoke each collector 52 in response to the notification, and receive environment information from each collector 52.

Deployment component 38 can generate monitor(s) 54 using any solution. For example, deployment component 38 can compile and/or link monitor engine 58, trigger(s) 50, and collector(s) 52 to generate a single executable file for monitor 54. In one embodiment, deployment component 38 generates a single monitor 54 for each trigger 50 having one or more links defined in link data 60. Alternatively, deployment component 38 can generate a single monitor 54 that is capable of managing the implementation of multiple triggers 50 and their corresponding collectors 52. Further, when a trigger 50 and/or collector 52 is not supported by one or more target computing environments 18, deployment component 38 can generate a unique monitor 54 for each computing environment 18, which only includes the supported trigger(s) 50 and collector(s) 52.

Once monitor(s) 54 are available, user 16 (FIG. 1) can select (e.g., by selecting the “DEPLOY MONITORS” button) to deploy the monitor(s) 54 to the set of target computing environments 70. In response, deployment component 38 can deploy the monitor(s) 54 for implementation on each of the target computing environments 18. To this extent, when multiple monitor(s) 54 are to be deployed, e.g., one monitor 54 for each selected trigger 50 and/or different monitors 54 for different configurations, deployment component 38 can select the appropriate monitor(s) 54 for each target computing environment 18 and provide the selected monitor(s) 54 for implementation.

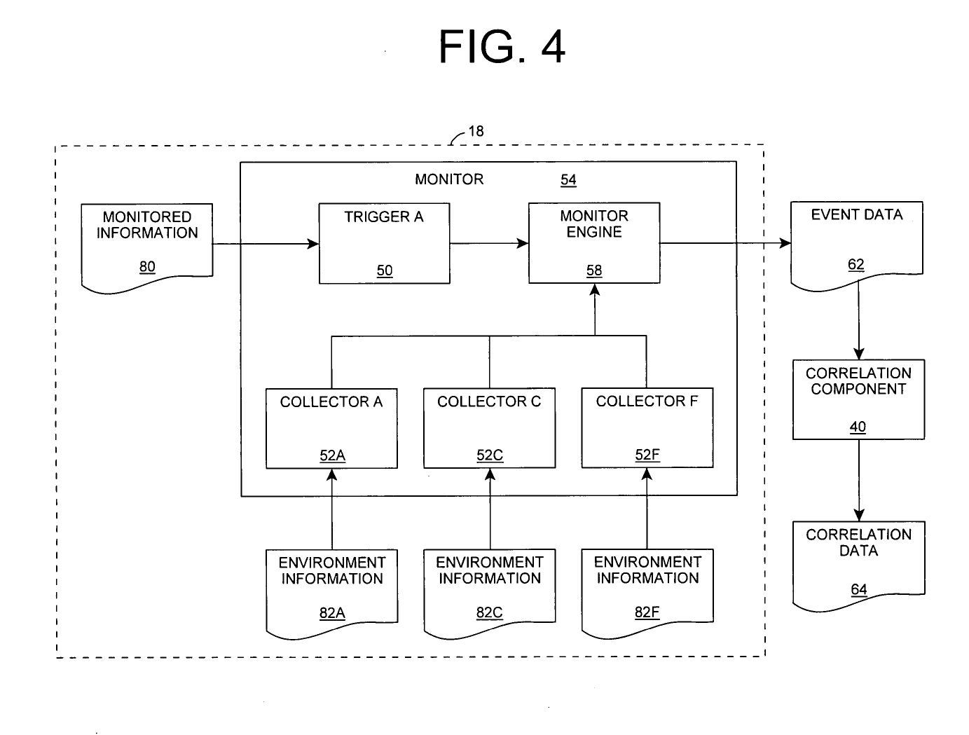

FIG. 4 shows a data flow diagram for an illustrative monitor 54 after implementation on a computing environment 18 according to an embodiment of the invention. Monitor 54 can be generated by deployment component 38 based on the set of links 78 defined for “TRIGGER A”. After initialization by monitor engine 58, trigger 50 obtains monitored information 80 about computing environment 18. As noted above, monitored information 80 can comprise any type of information on one or more resources, processes, events, etc., that is required by trigger 50 to determine the presence of a condition on computing environment 18. When monitored information 80 indicates the presence of the condition, trigger 50 can notify monitor engine 58. In response, monitor engine 58 can invoke each collector 52A, 52C, 52F, each of which collects a corresponding type of environment information 82A, 82C, 82F for computing environment 18. Monitor engine 58 can package all of the environment information 82A, 82C, 82F into event data 62.

Monitor 54 can provide event data 62 for processing by correlation component 40. After receiving event data 62, correlation component 40 can analyze event data 62 together with event data received from other monitor(s) 54 and/or other events, to establish any relationships between events and/or to determine a root cause of one or more events. Correlation component 40 can generate correlation data 64 for presentation to user 16 (FIG. 1) that comprises the results of the analysis of event data 62, e.g., a set of relationships, a set of root causes, and/or the like.

While shown and described herein as a method and system for managing a set of monitors, it is understood that the invention further provides various alternative embodiments. For example, in one embodiment, the invention provides a program product stored on a computer-readable medium, which when executed, enables a computer infrastructure to manage the set of monitors. To this extent, the computer-readable medium includes program code, such as monitor system 30 (FIG. 1), which implements the process described herein. It is understood that the term “computer-readable medium” comprises one or more of any type of tangible medium of expression (e.g., physical embodiment) of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), as a data signal traveling over a network (e.g., during a wired/wireless electronic distribution of the program product), on paper (e.g., capable of being scanned in as electronic data), and/or the like.

In another embodiment, the invention provides a method of generating a system for managing a set of monitors. In this case, a computer infrastructure, such as computer infrastructure 12 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising, and/or fee basis. That is, a service provider, such as a Solutions Integrator, could offer to manage a set of monitors as described herein. In this case, the service provider can manage (e.g., create, maintain, support, etc.) a computer infrastructure, such as computer infrastructure 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a monitor, the method comprising:
obtaining a set of triggers, each trigger being capable of monitoring a computing environment for a condition;
obtaining a set of collectors, each collector being capable of collecting environment information for the computing environment;
obtaining a set of links, each link defining a relationship between a trigger in the set of triggers and a collector in the set of collectors; and
generating a monitor based on the set of links.

2. The method of claim 1, further comprising deploying the monitor for implementation on the computing environment.

3. The method of claim 2, further comprising obtaining a plurality of computer systems, the deploying being performed for each of the plurality of computer systems.

4. The method of claim 1, further comprising:
receiving event data from the monitor; and
generating correlation data based on the event data.

5. The method of claim 1, the obtaining a set of links including generating a user interface for enabling a user to manage the set of links.

6. The method of claim 1, the obtaining a set of links including obtaining a set of default links for a trigger.

7. The method of claim 1, at least one of the obtaining a set of triggers and the obtaining a set of collectors including:
obtaining configuration information for the computing system; and
generating at least one of the set of triggers and the set of collectors based on the configuration information.

8. A system for managing a monitor, the system comprising:
a system for obtaining a set of triggers, each trigger being capable of monitoring a computing environment for a condition;
a system for obtaining a set of collectors, each collector being capable of collecting environment information for the computing environment;
a system for obtaining a set of links, each link defining a relationship between a trigger in the set of triggers and a collector in the set of collectors; and
a system for generating a monitor based on the set of links.

9. The system of claim 8, further comprising a system for deploying the monitor for implementation on the computing environment.

10. The system of claim 8, further comprising:
a system for receiving event data from the monitor; and
a system for generating correlation data based on the event data.

11. The system of claim 8, the system for obtaining a set of links including a system for generating a user interface for enabling a user to manage the set of links.

12. The system of claim 8, the system for obtaining a set of links including a system for obtaining a set of default links for a trigger.

13. The system of claim 8, at least one of the system for obtaining a set of triggers and the system for obtaining a set of collectors including:
a system for obtaining configuration information for the computing system; and
a system for generating at least one of the set of triggers and the set of collectors based on the configuration information.

14. A program product stored on a computer-readable medium, which when executed, enables a computer infrastructure to manage a monitor, the program product comprising computer program code for enabling the computer infrastructure to:
obtain a set of triggers, each trigger being capable of monitoring a computing environment for a condition;
obtain a set of collectors, each collector being capable of collecting environment information for the computing environment;
obtain a set of links, each link defining a relationship between a trigger in the set of triggers and a collector in the set of collectors; and
generate a monitor based on the set of links.

15. The program product of claim 14, further comprising computer program code for enabling the computer infrastructure to deploy the monitor for implementation on the computing environment.

16. The program product of claim 14, further comprising computer program code for enabling the computer infrastructure to:
receive event data from the monitor; and
generate correlation data based on the event data.

17. The program product of claim 14, the computer program code for enabling the computer infrastructure to obtain a set of links including computer program code for enabling the computer

18. The program product of claim 14, the computer program code for enabling the computer infrastructure to obtain a set of links including computer program code for enabling the computer infrastructure to obtain a set of default links for a trigger.

19. The program product of claim 14, the computer program code for enabling the computer infrastructure to obtain at least one of a set of triggers and a set of collectors including computer program code for enabling the computer infrastructure to:
obtain configuration information for the computing system; and
generate at least one of the set of triggers and the set of collectors based on the configuration information.

20. A method of generating a system for managing a monitor, the method comprising:
providing a computer infrastructure operable to:
obtain a set of triggers, each trigger being capable of monitoring a computing environment for a condition;
obtain a set of collectors, each collector being capable of collecting environment information for the computing environment;
obtain a set of links, each link defining a relationship between a trigger in the set of triggers and a collector in the set of collectors; and
generate a monitor based on the set of links.
